(19) United States
(12) Patent Application Publication
(10) Pub. No.: US 2007/0031696 A1
(43) Pub. Date: Feb. 8, 2007

(54) Plain bearing composite material comprising a sputtered bearing coating

(76) Inventors: Gerhard Caspers, Bad Schoenborn (DE); Werner Schubert, Wiesloch (DE); Klaus Deicke, Untereisesheim (DE); Friedhelm Gerlach, Westoverledingen (DE)

Correspondence Address: DREISS, FUHLENDORF, STEIMLE & BECKER, POSTFACH 10 37 62, D-70032 STUTTGART, DE

(21) Appl. No.: 10/575,848

(22) PCT Filed: Apr. 2, 2004
(86) PCT No.: PCT/EP04/03494

§ 371 Date: Apr. 14, 2006

(30) Foreign Application Priority Data
Nov. 21, 2003 (DE) 10355547.1

(51) Int. Cl. B32B 15/01; B23K 35/00; B32B 15/20

(52) U.S. Cl. 428/652; 428/681; 428/676; 428/646; 384/912

(57) ABSTRACT

The invention relates to a plain bearing composite material comprising a steel carrier layer, a carrier layer which is cast, sintered or cladded thereon, the carrier layer being made of bronze or brass, and a bearing coating on the carrier layer or on an intermediate layer, the bearing coating being made of a bearing coating material based on aluminium/tin/copper, to increase load-bearing capacity and resistance to wear of the plain bearing composite material. According to the invention, the composition of the plain bearing materials is AlSn(22-30)Cu(2.3-2.8), optionally, comprising upto 2 wt. % Ni, Si, Mn and impurity related elements up to, respectively, 0.5 wt. %, the total quantity thereof not amounting to more than 1 wt. %, and the hardness of the bearing coating being between 110-150 HV 0.002.

This application is the national stage of PCT/EP2004/003494 filed on Apr. 2, 2004 and also claims Paris Convention priority of DE 103 55 547.1 filed on Nov. 21, 2003.

The present invention concerns a plain bearing composite material comprising a steel back layer, a carrier layer of bronze or brass which is cast, sintered or cladded thereon, and a sliding layer of a sliding layer material on the basis of aluminium/tin/copper, which is sputtered onto the carrier layer or an intermediate layer.

Conventional plain bearing composite materials are used, in particular, for producing plain bearing shells in automotive applications, in particular, for bearing the crankshaft or for connecting rod bearing shells, and comprise a sputtered sliding layer on the basis of aluminium/tin, i.e. produced through cathode sputtering. The Assignee produces and distributes e.g. plain bearing shells for automotive applications, comprising a sputtered sliding layer of AlSn20 and AlSn20Cu1. The Assignee has also published a product description “PVD-Beschichtete Hochleistungsgleitlager” (PVD coated high-performance plain bearings) which describes the basics of bearing shell sputtering.

At the end of the 80-es, one tried to produce plain bearing composite materials for higher loads on the basis of plain bearing composite materials designed for lesser loads and having a galvanically separated sliding layer or a cast or cladded sliding layer on the basis of aluminium/tin with a hardness of approximately 35 to 45 HV 0.002. One discovered that the load capacity and wear resistance could be improved by using sputtered sliding layers having a hardness of between 70 and 90 HV 0.002.

However, one quickly realized that a further increase in the hardness of the sputtered sliding layers caused undesired embrittlement of the sliding layer material resulting in rapid failure of a plain bearing produced from such a plain bearing composite material. For this reason, plain bearing composite materials of this type were used having a sputtered sliding layer of a hardness in the range between 80 and maximally 100 HV 0.002.

EP 0 272 447 A2, filed in 1986, discloses an increase in hardness up to values of 113 HV at the bearing top and 45 HV at the ends of the bearing shell in an intermediate state prior to thermal treatment, through use of an oxygen atmosphere, with these values being reduced to approximately 92 HV 0.002 after thermal treatment. This shows the desire to increase the hardness at that time. Today, however, experts try to obtain a moderate hardness in the range between 70 and 100 HV 0.002 for plain bearing composite materials of this type.

DE 36 29 451 C2 discloses a plain bearing composite material of this type and mentions an AlSn20Cu1 alloy as a sliding layer and an AlSi4Sn15Pb10 alloy. This document also reflects the obsolete desire for a sliding layer of extreme hardness.

EP 0 265 937 A1 of the present Assignee already realizes that it is possible to obtain suitable sliding layer compositions having a final hardness of the sputtered sliding layer material of between 75 and 97.5 HV 0.002 in connection with AlSn5Cu, AlSn10Cu, AlSn20Cu, AlSn30Cu, AlSn40Cu, AlSn10Pb10Cu. This document also proposes use of an oxygen atmosphere to increase the portion of oxidic components in the sliding layer material and hence the hardness compared to values of approximately 60 HV 0.002.

The stem-shaped layered structure of sputtered sliding layers disclosed in EP 0 300 993 A1 has proven to be entirely unsuitable in practice, since the stem shape is highly brittle, irrespective of the actual composition of the sliding layer material.

WO 96/33352 discloses a plain bearing shell for automotive applications, consisting of a plain bearing composite material having a steel back layer, a carrier layer of lead bronze and a sliding layer of an AlSn20Cu0.25 alloy which is disposed thereon using electron beam vapor deposition. This document broadly mentions that the sliding layer material can comprise 15 to 35 weight % of tin, 0.1 to 3.0 weight % of copper, and the rest aluminium. The single embodiment, however, discloses the mentioned AlSn20Cu0.25 composition.

It has turned out that a sliding layer disposed through electron beam vapor deposition has a less suitable metallurgical structure and a smaller loading capacity than a sliding layer disposed through cathode sputtering, i.e. a sputtered sliding layer.

U.S. Pat. No. 5,445,896 discloses a plain bearing composite material of this type, which mentions a possible composition of 10 to 80 weight % of Sn, 0.1 to 5 weight % of Cu, 0.05 to 3 weight % of Sb, the rest being Al, and optionally up to 10 weight % of Pb and Bi and moreover optionally up to 5 weight % of Si. All embodiments contain 1 weight % of copper and 0.5 weight % of antimony. The hardness values stated in table 1 are mainly below 100 HV.

It is the underlying purpose of the present invention to improve a plain bearing composite material of this type for producing plain bearing elements, in particular, plain bearing shells for automotive applications in such a manner that the loading capacity and wear resistance are improved to adjust a plain bearing element produced therefrom to the permanently increasing demands of modern combustion engines.

This object is achieved in accordance with the invention with a plain bearing composite material of the above-mentioned type in that the composition of the plain bearing material is AlSn(22-30)Cu(2.3-2.8), optionally with up to 2 weight % of each of Ni, Si, Mn, and impurity-related components of up to 0.5 weight % each, however, in total maximally 1 weight %, wherein the hardness of the sliding layer is 110 to 150 HV 0.002.

The present invention has surprisingly shown that by increasing the copper content to the claimed range and with a tin content within the claimed range, the loading capacity and the wear resistance can be increased by increasing the hardness of the sliding layer to a range of between 110 and 150 HV 0.002 without causing embrittlement of the sliding layer material. Up to now, it was assumed that it is not possible to obtain a suitable plain bearing composite material or plain bearing element made therefrom for automotive applications using plain bearing composite materials of this type of more than 100 HV 0.002, since it was assumed that an increase in hardness would reduce the adaptive behavior and the capacity of embedding microscopic foreign materials into the plain bearing material to an unacceptable extent. One also assumed that the adhesive strength of the sputtered sliding layer would no longer be sufficient to prevent separation. It has now surprisingly turned out that this does not apply for the claimed composition of the plain bearing material and that it is possible to obtain a very great hardness resulting in good wear resistance, thereby still unexpectedly providing sufficient ductility for embedding foreign bodies.

There is a test method that is easy to perform for testing, in advance, the suitability of a plain bearing composite material of this type for common loads that occur in combustion engines. One can assume that the sliding layer is sufficiently ductile if scratching the sliding layer with a fine blade, e.g. a carpet knife, down to the carrier layer, produces a material displacement along the scratch without sliding layer particles being chipped off, which would be the case if the sliding layer material were excessively brittle.

In contrast to the opinion of the experts that plain bearing composite materials of this type should have a moderate hardness in the range of between 70 to maximally 100 HV, the present invention showed that the composition with greater hardness in the claimed range had sufficient ductility of the sliding layer material, to ensure good embedding behavior or adjustment behavior of the sliding layer material during operation. This is the pre-condition for permanent good wear resistance and high loading capacity.

Preferred compositions of the sliding layer material and preferred hardnesses of the sliding layer are stated in the dependent claims.

A lead-free sliding layer material or a completely lead-free plain bearing composite material have proven to be particularly advantageous.

In one preferred embodiment of the inventive plain bearing composite material, the sliding layer material is composed of an AlSn(22-30)Cu(2.3-2.8) alloy, at most containing impurity-related components, preferably less than 0.05 weight % each.

A preferred composition of the inventive plain bearing material is AlSn25Cu2.5.

It has turned out that an Inventive plain bearing composite material or a plain bearing element produced therefrom has a higher wear resistance and additionally higher loading capacity compared to a composite material of AlSn20Cu1 sliding layer material of this type. The sliding layer or the sliding layer material having a hardness within the claimed range still has sufficient ductility to achieve good embedding and adaptive behavior, such that, in total, the inventive material can bear higher loads and has a higher wear resistance compared to conventional materials or sliding elements produced therefrom.

1-12. (canceled)

13. A plain bearing composite material comprising:
a steel back layer;
a carrier layer of bronze or brass which is cast, sintered or cladded onto said steel back layer; and
a sliding layer sputtered onto said carrier layer, said sliding layer comprising AlSn(22-30)Cu(2.3-2.8), said sliding layer having a hardness between 110 and 150 HV 0.002.

14. The plain bearing composite material of claim 13, further comprising up to 2 weight % of each of Ni, Si, and Mn, and impurity-related components of up to 0.5 weight % each, but in total not more than 1 weight %.

15. The plain bearing composite material of claim 13, further comprising an intermediate layer disposed between said carrier layer and said sliding layer.

16. The plain bearing composite material of claim 13, wherein said sliding layer is lead-free.

17. The plain bearing composite material of claim 16, wherein the plain bearing composite material is lead-free.

18. The plain bearing composite material of claim 13, wherein the plain bearing composite materials contains no antimony.

19. The plain bearing composite material of claim 13, wherein a composition of said sliding layer is AlSn(22-28)Cu(2.3-2.8).

20. The plain bearing composite material of claim 19, wherein a composition of said sliding layer is AlSn(23-28)Cu(2.3-2.8).

21. The plain bearing composite material of claim 20, wherein a composition of said sliding layer is AlSn(23-27)Cu(2.4-2.7).

22. The plain bearing composite material of claim 13, wherein said hardness of said sliding layer is 110 to 140 HV 0.002.

23. The plain bearing composite material of claim 22, wherein said hardness of said sliding layer is 110 to 130 HV 0.002.

24. The plain bearing composite material of claim 23, wherein said hardness of said sliding layer is 115 to 130 HV 0.002.

25. The plain bearing composite material of claim 13, wherein said carrier layer is formed by a CuPb(8-25)Sn(2-12) alloy.

26. The plain bearing composite material of claim 13, wherein said carrier layer is formed by a CuZn(20-32) alloy.

27. The plain bearing element, a plain bearing shell for automotive applications, a crankshaft bearing shell, or a connecting rod bearing shell comprising the plain bearing composite material of claim 13.
